(19) United States
(12) Patent Application Publication
(10) Pub. No.: US 2014/0253503 A1
(43) Pub. Date: Sep. 11, 2014

(54) TOUCH SYSTEM CONFIGURED ON METAL SURFACE WITH X-Y AND FORCE DETECTION

(71) Applicant: BANG & OLUFSEN A/S, Struer (DK)

(72) Inventor: Finn EJLERSEN, Holstebro (DK)

(73) Assignee: BANG & OLUFSEN A/S, Struer (DK)

(21) Appl. No.: 14/197,387

(22) Filed: Mar. 5, 2014

(30) Foreign Application Priority Data
Mar. 5, 2013 (DK) PA 2013 00117

(51) Int. Cl. G06F 3/041; G06F 3/044; G01L 1/14

(52) U.S. Cl. CPC G06F 3/0414; G01L 1/142; G06F 3/044; G06F 2203/04105
USPC 345/174

(57) ABSTRACT

A sensitive precision detector to sense user given control input in terms of activation on a cover plate by moving the finger with an easy touch, or with a force vertically or with a force in circular or elliptical movements on the surface of the cover plate.

The precision detector is configured as a structure having the cover plate made in a conducting material.

A first member constitutes the cover plate which is pre-processed to have a certain ability to be depressed along the Z-axis upon activation from a finger touch.

The first member constitutes the one electrode of a capacitor and having the second member as the other electrode of the capacitor.

Change in the capacitance is detected upon activation with a force provided on the cover plate.

This application claims the benefit of Danish Patent Application No. PA 2013 00117 filed Mar. 5, 2013, the entire contents of which are incorporated herein by reference.

### BACKGROUND OF THE INVENTION

The present invention relates to general improvement in use of touch sensitive input detection means in apparatus having metal surfaces.

In prior art many different solutions support touch sensitive man-machine-operation in the control of the equipment, with the operational means implemented as touch pads. Depending on which material constitutes the surface of the equipment, different technologies are applied. Surfaces may be of glass, plastics and metal and different means and technologies are applied accordingly. Capacitive detection, strain gauge- and piezo-electric principles are known technologies.

From WO 2008/071196 is a construction known where a capacitor-like device having a deformable cover plate, used as an input device is disclosed. The cover plate acts as one electrode which is arranged above the second electrode forming a capacitor. By deflecting the upper electrode, due to a user's action, the capacitance changes, whereby an input action is detected. In order to reduce the error margin and to assure that the correct input is detected and received, the prior art provides isolated capacitance elements, at least in the lower part of the capacitor, i.e. in each void (the space between the upper and lower electrodes separated by an air gap). In some instances where a linear input device is desired an array of distinct capacitive cells is used. In these systems the risk of inputting mistakes is relatively high in that when a user depressing the upper part of the capacitor the deflection of the upper part may influence the capacitance of neighbouring capacitor elements.

### SUMMARY OF THE INVENTION

In the present invention a variant of the capacitive detection is disclosed. The proposed principle makes it possible to implement the controls as part of the metal front panel without any seams, openings or disruptions in the surface of the front panel and thus on the surface of the apparatus.

The method allows e.g. the user to perform touch control on the metal front panel.

As opposed to existing technologies, the proposed principle enables both x-y position detection of the user's finger as well as force detection (z-detection). This enables for detection of a wide range of different gestures.

As opposed to the existing piezo-electric technology, the proposed principle enables long time key force detection which is very useful e.g. for scrolling. As the magnitude of the force can be detected, the scrolling speed can be proportional to the key force.

In addition the touch sensitive device as disclosed in the invention is very sensitive in detecting the touch from the finger of the user, without being noise sensitive.

In summary the characteristics of the device having plurality of advantages are:
Touch on a metal surface.
Simple construction.
Long time key force can be detected.
Magnitude of force can be detected, thus e.g. scroll speed in an application can be dependent on the force applied.
Can be extremely sensitive, thus applied force <0.25 N can be detected.
Reliable: no ‘moving’ parts.
Long lifetime: no wear and tear.
Very high noise immunity; can be completely shielded against electrical noise, (covered by a metal plate).
Can be completely sealed against dirt and water, can work under water.
Since it is the deformation of the metal plate that is detected the key can be activated with gloves or pen/stick, conductive or nonconductive materials.
Flexible design, as the metal plate could be replaced by any other conductive material, e.g. carbon coated plastics, film printed with conductive ink like carbon or silver, etc.

The touch sensitive principle may be applied in any type of equipment like consumer electronics, cell phones, cars, instrumentation, media player, PC's etc.

In summary the aspects of the invention are:
A sensor construction has been developed consisting of a metal plate which can be deformed by applying mechanical force, thus yielding a small change in capacitance between the metal plate and a conducting pad underneath the metal plate.
The sensor can be used to detect very small forces applied by a finger touch or other means by measuring the capacitance changes using a highly sensitive detection device.
The output of the detection device is proportional to the x-y position and to the applied force, making it possible to use the sensor for user interaction, e.g. controlling functions (switches or analogue controls) of any electronic device.

The sensor construction principles are:
Thin metal plate mounted above the conducting pad (as part of a PCB or other carrier) using non-conductive spacer material.
The distance between the metal plate and the conductive part is controlled by the thickness of the spacer material. The spacer material is fixed between the metal plate and the carrier of the conducting pad by using adhesive or glue.
Alternatively, the separate spacer material can be omitted by integrating the space between the electrodes as a recess in the thin metal plate. This is achieved by milling or etching the recess into the metal plate, or by creating an elevated metal plate using extrusion thus creating a metal dome above the conducting pad.
Alternatively, the thin metal plate can be made part of a thicker metal plate forming the front panel of the electronic device the sensor is part of. This is achieved by first milling a deeper recess into the thick metal plate creating space for the carrier of the conductive pad. After this, the principles above can be used for creating the actual sensor.
Sensor layout as a Key matrix or x-y touch input device and scroll wheels.

A first aspect of the invention is to apply the conductive surface of the apparatus as an element of the touch detective means:

A detection device for sensing user given control commands in terms of activation on a cover plate with the finger by a single touch, or by a force on the cover plate or along the plane of the cover plate, said device characterised by:

Said cover plate having a plane in a XY plane and a thickness along a Z-axis, substantially perpendicular to said XY plane

a first member being the cover plate being made from a conductive material, the cover plate has a certain ability to be depressed along the Z-axis upon activation from a finger; and
the first member being configured to act as one electrode of a capacitor; and
a second member being made from a conductive material and configured to act as the other electrode of a capacitor; and
where the first member is electrically isolated from the second member; and
the first member and the second member is assembled in a manner so the assembly constitutes an electrical capacitor having as electrodes, the first and the second members; and
where the second member is divided into 3 or more sensing pads, each sensing pad detecting separate inputs.

This configuration having separate input pads as the lower part of the electrode assembly where the detection device is connected to a micro-processor calculate, such that input from the various pads may be inputted in the calculations in order to calculate the exact position of the finger relative to the pads and/or the speed of the finger across or around the upper electrode, provides the possibility that in addition to detecting a simple pressure from a user's finger in one pad thereby activating a specific feature, the relative position of the finger (calculated by the device) may activate other functions, and further the change of pressure, corresponding to the movement of the finger across or around the detection device will provide a further input characteristic. The detection device of the invention may in these aspects be compared to a touch sensitive screen. The design options with the present invention is much higher and wider, in that the calculations makes it possible to manufacture the surface from a wide variety of desirable materials, and still maintain the input characteristics of a touch sensitive screen.

A second aspect of the invention is an electrical circuit that detects the depressing magnitude of the user given force along the Z-axis on the surface of the apparatus:

A detection device, where the force of the finger activated in the Z-axis direction is detected as a magnitude of force with proportional changes in the capacity of the capacitor that is constituted by the first member electrode and the second member electrode.

The calculated change in capacity is based on the formula:

The capacity C between the metal plate and the conductive pad is:

$$C = {ɛ}_{o} \times {ɛ}_{r} \times \frac{A}{d}$$

### Where

A is the area of the conductive pad, and
d is the distance (air gap) between the metal plate and the conductive pad.
∈ₒ is the dielectric constant in vacuum.
∈ᵣ is the dielectric constant of the material in between the two electrodes of the capacitor;

And where

a specific x, y position is detected, the position of the user finger and a given input is calculated accordingly.

If a force is applied to the metal plate the plate is deformed (bent downwards) causing the distance d to become smaller. Thus the capacity C becomes larger.

The capacity is measured with a high resolution capacity-to-digital converter and fed into a microprocessor for further signal processing. A standard CDC with 16 bits of resolution is sufficient.

The CDC may be configured in a grounded mode of operation. The first member cover plate is connected to ground. The second member pad is connected to the input of the CDC.

When a button is pressed, the capacitance that is measured by the CDC, changes. When the capacitance changes to such an extent that a preset threshold is exceeded, the CDC registers this as a button touch/activation.

Preprogrammed threshold levels are used to determine if a change in capacitance is due to a button being activated.

The sensitivity is dependent on the thickness and stiffness of the metal, the nominal distance between the electrodes of the capacitor, the diameter of the detector cell and signal to noise of the CDC.

In a preferred embodiment with a surface plate with a thickness of 0.5 mm aluminum, and 0.1 mm gaps between the electrodes and the cell with a 17 mm diameter it is possible to detect <25N with the CDC. Thus, a light touch is enough to activate this button.

In a preferred embodiment a control function having variable speed may be provided. The proportional changes detected according to the force may be used to provide a control function that acts with a speed according to the applied force. The higher force the higher speed and the lower force the lover speed.

### BRIEF DESCRIPTION OF THE DRAWINGS

In the following a preferred embodiment of the invention will be described with reference to the drawings in which:

FIG. 1 illustrates a detection device according to an embodiment of the invention;

FIG. 2 illustrates the detection device according to an embodiment of the invention in which a force is applied to a metal plate and the plate is shown as deformed;

FIG. 3 illustrates an arrangement of sensing pads according to the device of the invention;

FIG. 4 illustrates alternative arrangements of the sensing pads according to the device of the invention;

FIG. 5 illustrates the detection device in which a recess is extruded in a metal plate of the detection device;

FIG. 6 illustrates the detection device in which a recess is milled or etched in a metal plate of the detection device;

FIG. 7 illustrates the detection device in which a recess is milled in a metal plate of the detection device and a recess is milled in a PCB; and

FIG. 8 illustrates the detection device in which a recess is milled in a metal plate of the detection device and instead of milling sub-recesses for individual sensors, these can be made by using a spacer with holes for each sensor.

### DETAILED DESCRIPTION

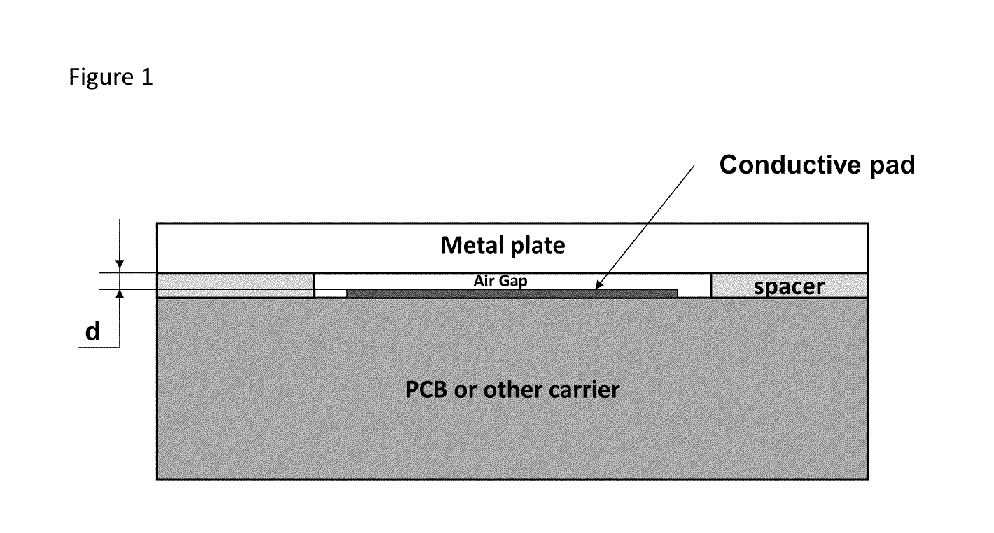

FIG. 1 displays the principle of the sensor means:

The capacitance C between the metal plate and the conductive pad is:

$$C = {ɛ}_{o} \cdot {ɛ}_{r} \cdot \frac{A}{d}$$

where A is the area of the conductive pad, d is the distance (air gap) between the metal plate and the conductive pad, ∈₀ is the permittivity in vacuum and ∈ᵣ is the relative permittivity.

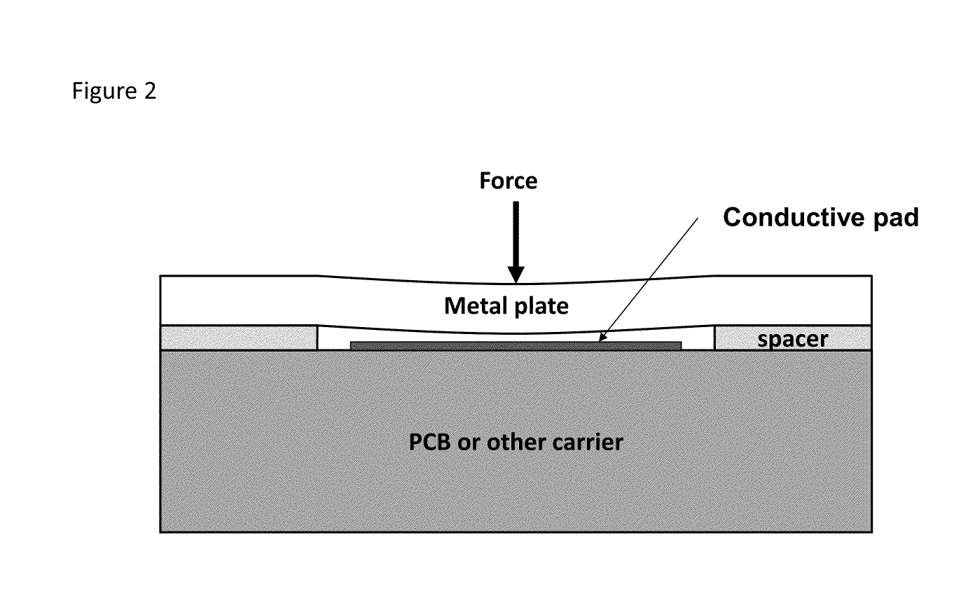

In FIG. 2 a force is applied to the metal plate and the plate is deformed (bent downwards) and causing the distance d between the metal plate and the PCB pad to become smaller. Thus the electrical capacitance becomes larger.

The capacitance is measured with an electronic Touch detector circuit containing a capacitance-to-digital converter and fed into a microprocessor for further signal processing.

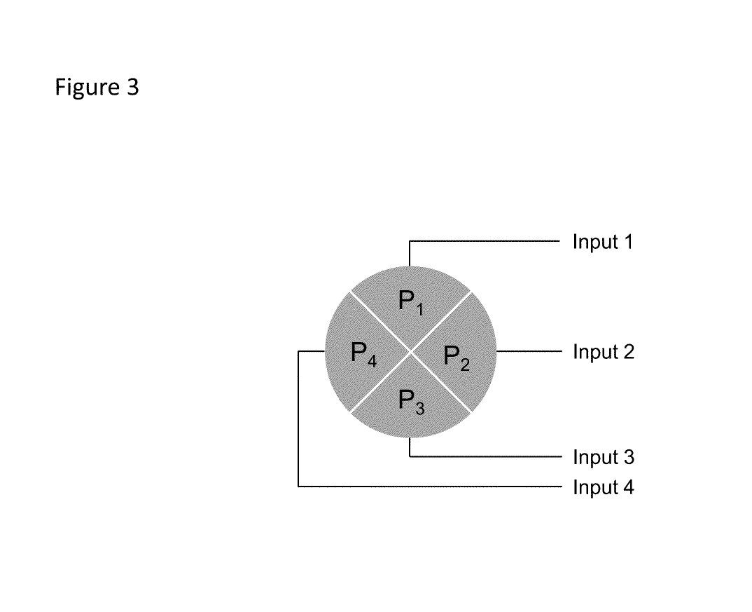

FIG. 3 the principles of the x-y position detection:

By dividing the sensor pad into four pads P1 through P4 as show below, the x-y position of the touch can be detected. The four pads are connected to four inputs on the electronic touch detector circuit. This circuit delivers output signals S1 through S4, proportional to the force applied to P1 through P4.

The touch position (x,y) and the force (z) can be calculated with these formulas:

$$x = \frac{S 2 - S 4}{z}$$

$$y = \frac{S 1 - S 3}{z}$$

$$Where z = S 1 + S 2 + S 3 + {S}_{4}$$

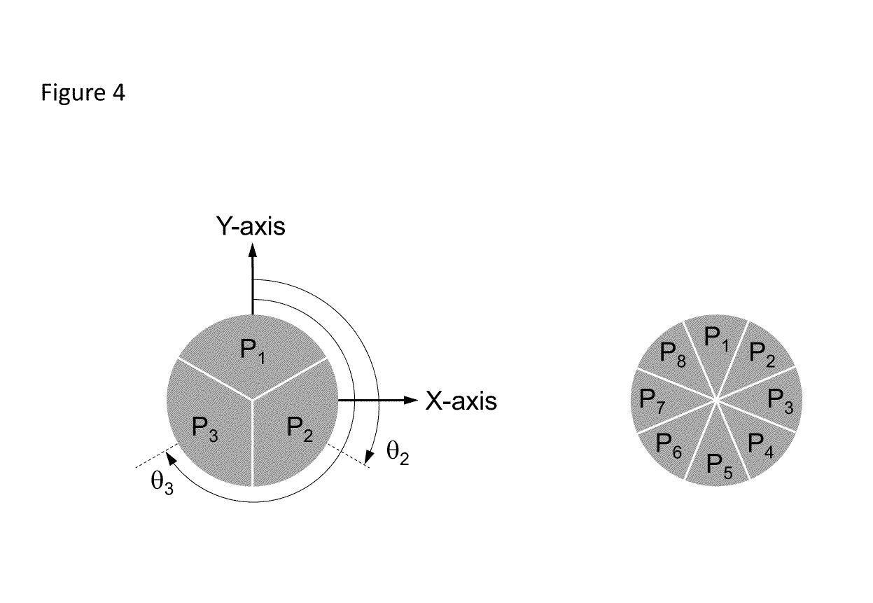

FIG. 4 displays alternative touch pad layouts.

The number of pads needed depends on the size of the touch area and the accuracy needed. For larger touch areas a higher number of pads may improve the accuracy.

Any number of pads can be used from a minimum of 3 pads. In principle the maximum number of pads is unlimited.

The touch x-y position and the force (z) can be calculated with these formulas:

$$x = \frac{S 1 sin θ 1 + S 2 sin θ 2 + S 3 sin θ 3 + … + Sn sin θ n}{z}$$

$$y = \frac{S 1 cos θ 1 + S 2 cos θ 2 + S 3 cos θ 3 + … + Sn cos θ n}{z}$$

$$where : z = S 1 + S 2 + S 3 + … + Sn$$

and where θᵢ is the angular position of the touch pads relative to the positive Y-axis.

As P1 always is chosen to be aligned with the Y-axis, θ₁ is always equal to zero here.

Alternative constructions are displayed below:

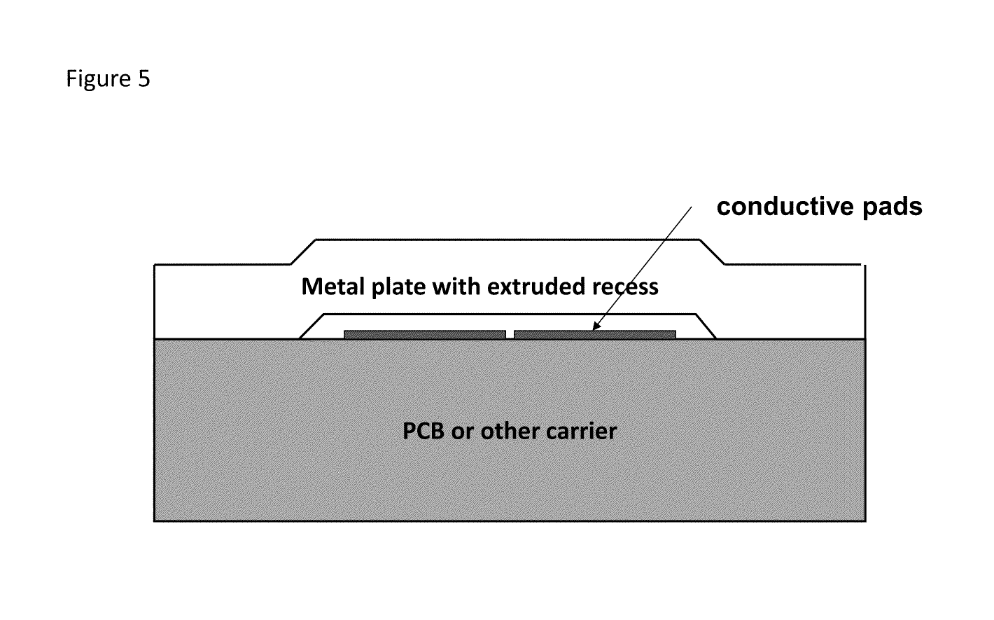

FIG. 5 displays how a recess is extruded in the metal plate.

Thus the gap can be controlled very accurately and the spacer is not needed. The metal plate is attached to the carrier with adhesive or glue.

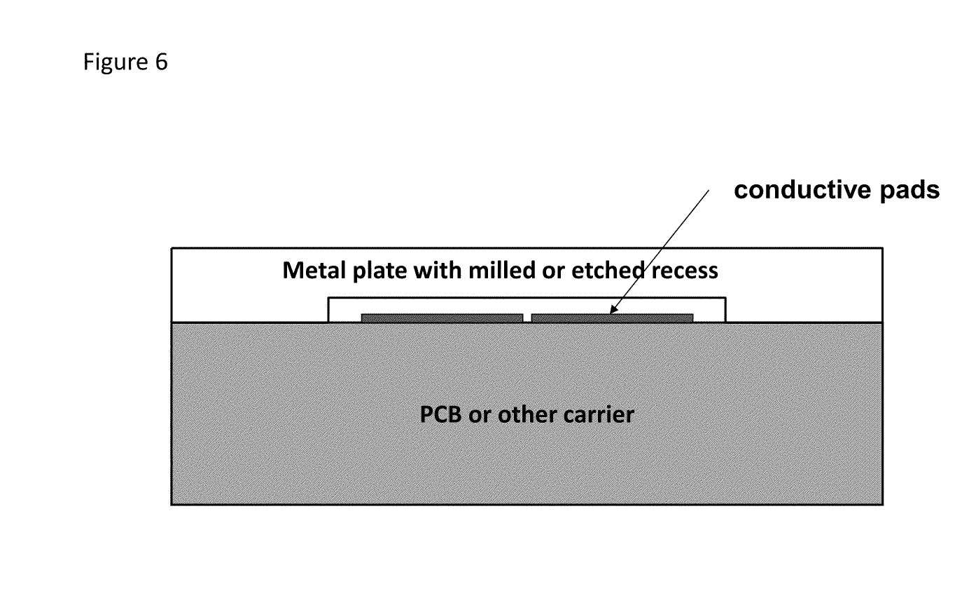

FIG. 6 displays how a recess is milled or etched in the metal plate.

Thus the gap can be controlled very accurately and the spacer is not needed.

The metal plate is attached to the carrier with adhesive or glue.

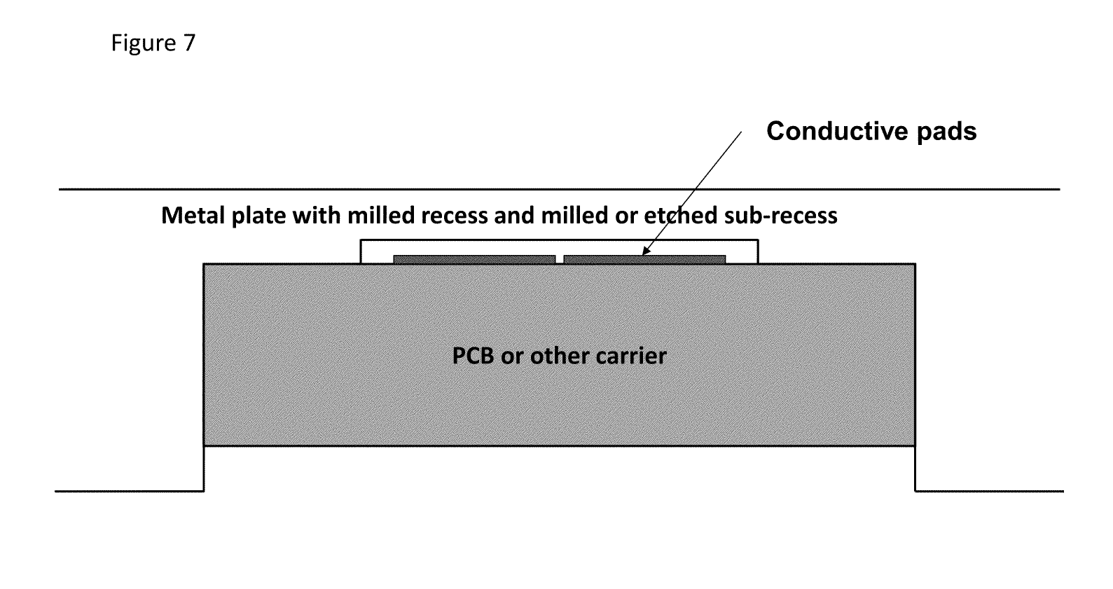

FIG. 7 displays a relatively thick metal plate in which a recess for the PCB is milled. In the active touch area a smaller recess is milled or etched as in alternative construction above.

This gives the impression that the operation panel is made from a thick solid metal plate, which opens up for some very attractive design possibilities. Thus the gap can be controlled very accurately and the spacer is not needed. The carrier is attached to the metal plate with adhesive or glue.

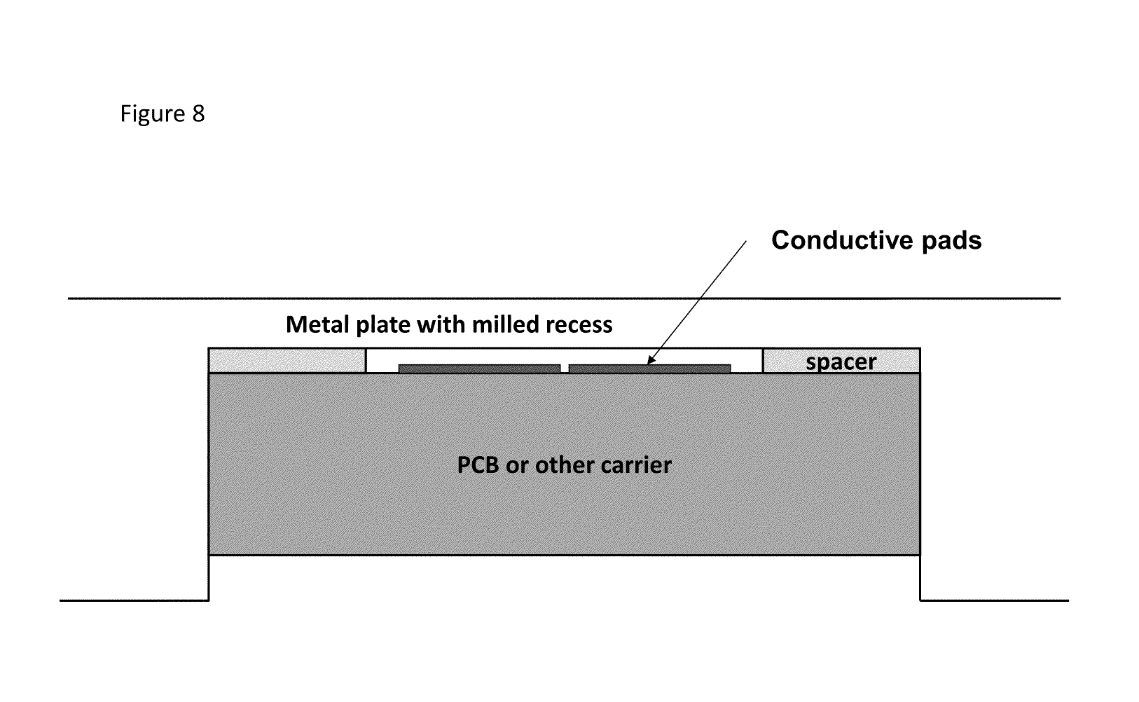

FIG. 8 displays an embodiment where instead of milling the sub-recess for the individual sensors; these can also be made by using a spacer with holes for each sensor.

What is claimed is:

1. A detection device for sensing user given control commands in terms of activation on a cover plate with the finger by a single touch, or by a force on the cover plate or along the plane of the cover plate, where said detection device is connected via capacitance to digital converter means to a micro-processor where said device is characterised by:
Said cover plate having a plane in a XY plane and a thickness along a Z-axis, substantially perpendicular to said XY plane
a first member being the cover plate being made from a conductive material, the cover plate has a certain ability to be depressed along the Z-axis upon activation from a finger; and
the first member being configured to act as one electrode of a capacitor; and
a second member being made from a conductive material and configured to act as the other electrode of a capacitor; and
where the first member is electrically isolated from the second member; and
the first member and the second member is assembled in a manner so the assembly constitutes an electrical capacitor having as electrodes, the first and the second members; and
where the second member is divided into 3 or more sensing pads, each sensing pad detecting separate inputs.

2. The detection device according to claim 1, wherein the device is having a 4 pad sensor, the position of the user given control command is defined as a touch position (x,y) and the force (z) is calculated as:
$$x = \frac{S 2 - S 4}{z}$$
$$y = \frac{S 1 - S 3}{z}$$
$$Where z = S 1 + S 2 + S 3 + {S}_{4}$$

3. The detection device according to claim 1, wherein the device is having a 3 pad sensor, the position of the user given control command is defined as a touch position (x,y) and the force (z) is calculated as:
$$x = \frac{S 1 sin θ 1 + S 2 sin θ 2 + S 3 sin θ 3 + … + Sn sin θ n}{z}$$
$$y = \frac{S 1 cos θ 1 + S 2 cos θ 2 + S 3 cos θ 3 + … + Sn cos θ n}{z}$$
$$where \text{:} z = S 1 + S 2 + S 3 + … + Sn$$
and where θᵢ is the angular position of the touch pads relative to the positive Y-axis.

4. The detection device according to claim 1, wherein proportional changes detected may be used to provide a control function that act with a speed according to the applied force.

5. The detection device according to claim 1, wherein the second member may be mounted directly on a printed circuit board.

6. The detection device according to claim 1, wherein the second member may be mounted on a nonconductive carrier.

7. The detection device according to claim 1, wherein the distance along the Z-axis between the first and the second member is obtained by placing a spacing member between said first and second members outside the area of the sensing pads.

8. The detection device according to claim 1, wherein the distance along the Z-axis between the first and the second member is obtained by milling, grinding or etching a recess into the first member, said recess facing the sensing pads.

9. A detection device according to claim 1, wherein a touch sensor detects the changes in capacity by means of a capacity to digital converter measurement principle.

10. The detection device according to claim 1, wherein the first member is a recess extruded cover plate.

11. The detection device according to claim 1, wherein the first member has one or more recess milled or etched on the backside of the cover plate.

12. An interactive media player having integrated the detection device according to claim 1, wherein the cover plate of the detection device is located fully visible on the media player when this is in the mode of normal operation.
